(19) United States
(12) Patent Application Publication
(10) Pub. No.: US 2018/0111169 A1
(43) Pub. Date: Apr. 26, 2018

(54) Parts Washing or Cleaning Device Including Redirectors

(71) Applicant: Alliance Manufacturing, Inc., Fond du Lac, WI (US)

(72) Inventor: David Nicholas Van Zon, Rosendale, WI (US)

(73) Assignee: Alliance Manufacturing, Inc., Fond du Lac, WI (US)

(21) Appl. No.: 15/624,154

(22) Filed: Jun. 15, 2017

Related U.S. Application Data
(60) Provisional application No. 62/412,515, filed on Oct. 25, 2016.

(51) Int. Cl. B08B 3/02; B05B 1/26; B65G 17/00

(52) U.S. Cl. CPC B08B 3/022; B65G 17/002; B05B 1/26

(57) ABSTRACT

The present invention relates to a parts washing device including redirectors wherein the redirectors change the direction of a stream of liquid. A fixture or carriage can be provided having a top with a surface including parts supports for supporting parts to be washed. The carriage can have one or more redirectors. Each redirector has a body with a passage with an inlet operable on an inlet axis and an outlet operable on an outlet axis. The outlet axis is oriented different than the inlet axis wherein a stream of water passing through the redirector changes direction. This allows the stream to be directed towards portions of the parts that are otherwise considered blind. Reaching the blind portions of the parts can be accomplished without the need for moving manifolds.

This United States utility patent application claims priority on and the benefit of provisional application 62/412,515 filed Oct. 25, 2016, the entire contents of which are hereby incorporated herein by reference.

### BACKGROUND OF THE INVENTION

### 1. Field of the Invention

The present invention relates to a parts washing device including redirectors wherein the redirectors change the direction of a stream.

### 2. Description of the Related Art

Many parts washers exist, both in conveyor systems and in batch systems. In a conveyor system, a fixture is moved along a conveyor path wherein parts contained on the fixture are sprayed with a liquid cleaning solution. In an indexing system, the fixture is moved to a particular location within the washer wherein it stops before being sprayed with solution to wash parts contained thereon. In a batch system, parts contained on a single fixture are washed one cycle at a time.

One or more moving manifolds can be used within parts washers. The manifolds move in order to position spray nozzles in a particular location and orientation wherein part areas, such as blind areas, can be washed. There are several drawbacks associated with moving manifolds.

Moving manifolds can be expensive to build and maintain. Further, the manifolds add complexity to the system and there are more moving parts. The manifolds can have clearance issues with conveyors, fixtures and parts, as well and other parts washer components. The physical size requirement adds to the size of the parts washing or cleaning systems or machines. Further, the use of manifolds can increase the maintenance burden due to failure and wear from increased part movements, thereby affecting operational run time availability.

Thus there exists a need for a parts washing device including one or more redirectors that solves these and other problems.

### SUMMARY OF THE INVENTION

The present invention relates to a parts washing device including redirectors wherein the redirectors change the direction of a stream of liquid. A fixture or carriage can be provided having a top with a surface including parts supports for supporting parts to be washed. The carriage can have one or more redirectors. Each redirector has a body with a passage with an inlet operable on an inlet axis and an outlet operable on an outlet axis. The outlet axis is oriented different than the inlet axis wherein a stream of water passing through the redirector changes direction. This allows the stream to be directed towards portions of the parts that are otherwise considered blind. Reaching the blind portions of the parts can be accomplished without the need for moving manifolds.

According to one advantage of the present invention, the plumbing can be fixed in location within the washer. The plumbing can be routed and fixed in locations that do not inhibit movement of carriages, indexing systems or components of the parts washer. According to another advantage of the present invention, redirectors can be provided to change the direction of a stream of the solution, other liquid or gas (such as air).

The redirectors can change the direction to any orientation. In one example, the redirection is 90 degrees, wherein an inlet stream moving vertically is redirected to a horizontal stream. Yet, other orientations, and any rotational orientation can be achieved.

According to another advantage of the present invention, more than one redirector can be used in sequence to change the direction of flow multiple times. This is advantageous in a scenario where there are challenges with respect to the layout of the parts contained on the carriage and it is desirable to direct liquid from a particular orientation but where other parts would otherwise preclude such washing.

In this regard, by using one or more redirectors, either individually or in sequence, all six sides of a part are accessible to the liquid even if there are blind holes that are not directly assessable from outside the fixture or carriage.

According to a further advantage of the present invention, the redirectors can be connected to the carriages and move therewith. Each fixture can be tailored to redirect flow of liquid in a pattern specific to the parts contained on the carriage.

According to a further advantage of the present invention, the redirectors allow the system to operate while simultaneously reducing or even eliminating the need for moving manifolds which are currently required to access blind holes. This advantageously reduces system complexity, reduces cost, reduces machine size requirements and increases the time that the machine can be operational.

It is appreciated that the redirectors of the present invention are useful in continuous conveying systems, indexing systems and batch systems. Further, the redirectors can be used in combination with traditional hard plumbed spray nozzles that spray onto the parts.

According to a further advantage of the present invention, the liquid stream bridges the gap from a primary nozzle (hard plumbed to machine) to the redirector on the carriage. This advantageously eliminates the need to hard plumb the plumbing to the redirectors, as hard plumbing lines create fixed obstructions that inhibit travel of the fixture on a path through the machine. This also allows for a simpler plumbing layout where space is often limited and direct routing of plumbing to a desired spray orientation can be problematic.

Similarly, in batch systems, the redirectors also can allow the user to overcome problematic plumbing geometries associated therewith.

According to another advantage of the present invention, elimination of moving manifolds also eliminates the space that traditionally is needed for the manifolds to operate. This can result in smaller machine footprints.

According to a still further advantage of the present invention, different carriages can be used to wash different parts within the confines of a single machine without the need for a complete overhaul. In this regard the hard plumbing could be set to run with multiple carriage configurations wherein different nozzles are operational depending upon the configuration.

According to a still further advantage of the present invention, the redirectors can be used with both liquids and gasses as requirements dictate.

Other advantages, benefits, and features of the present invention will become apparent to those skilled in the art upon reading the detailed description of the invention and studying the drawings.

### BRIEF DESCRIPTION OF THE DRAWINGS

FIG. 1 is a top view of a carriage containing parts to be washed.

FIG. 2 is a side view of the carriage illustrated in FIG. 1 (direction of travel towards viewer of figure).

FIG. 3 is a cross-sectional view taken along line 3-3 in FIG. 1.

FIG. 4 is a cross-sectional view taken along line 4-4 in FIG. 1.

FIG. 5 is close up cross-sectional view of a redirector.

FIG. 6 a perspective view of an indexing system showing two carriages.

FIG. 7 is a partial perspective view showing two carriages in a machine.

### DETAILED DESCRIPTION OF PREFERRED EMBODIMENTS

While the invention will be described in connection with one or more preferred embodiments, it will be understood that it is not intended to limit the invention to those embodiments. On the contrary, it is intended to cover all alternatives, modifications and equivalents as may be included within the spirit and scope of the invention as defined by the appended claims.

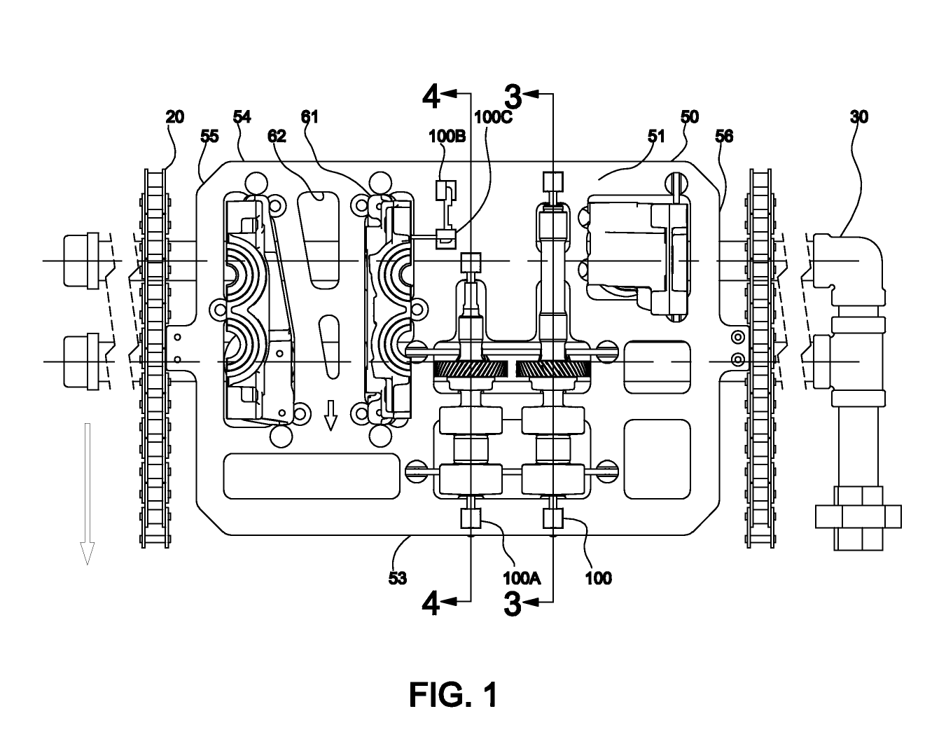

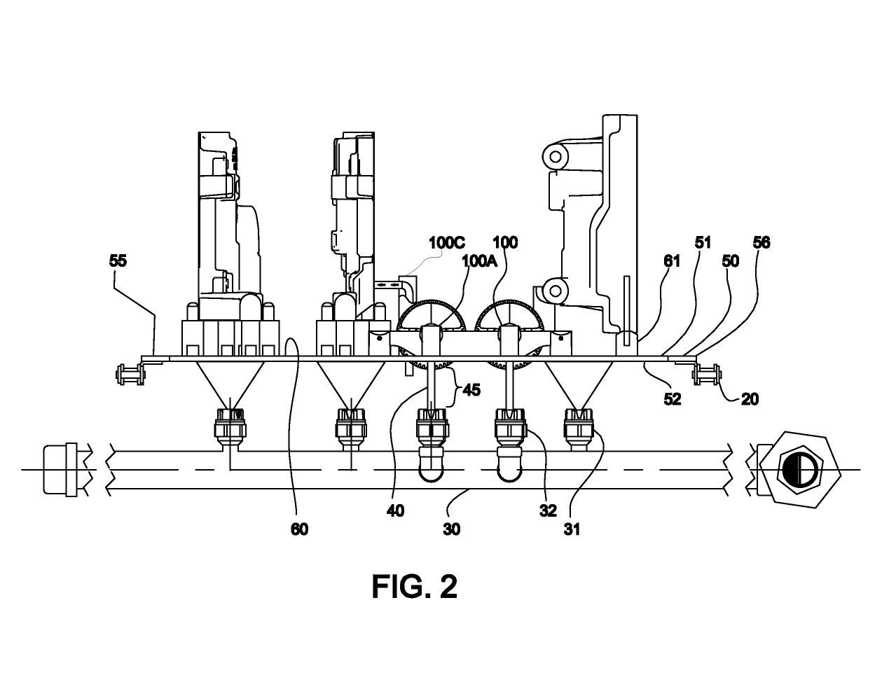

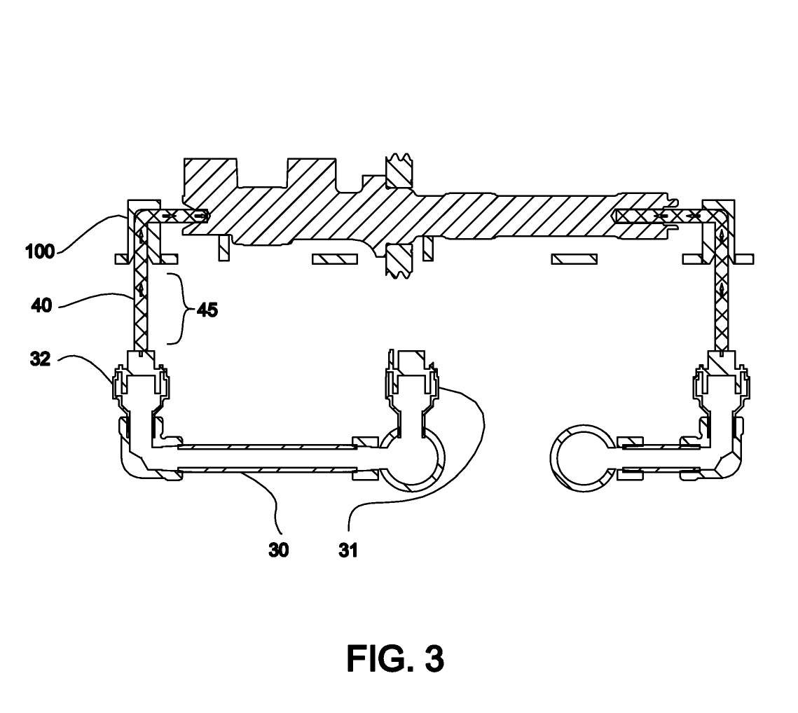

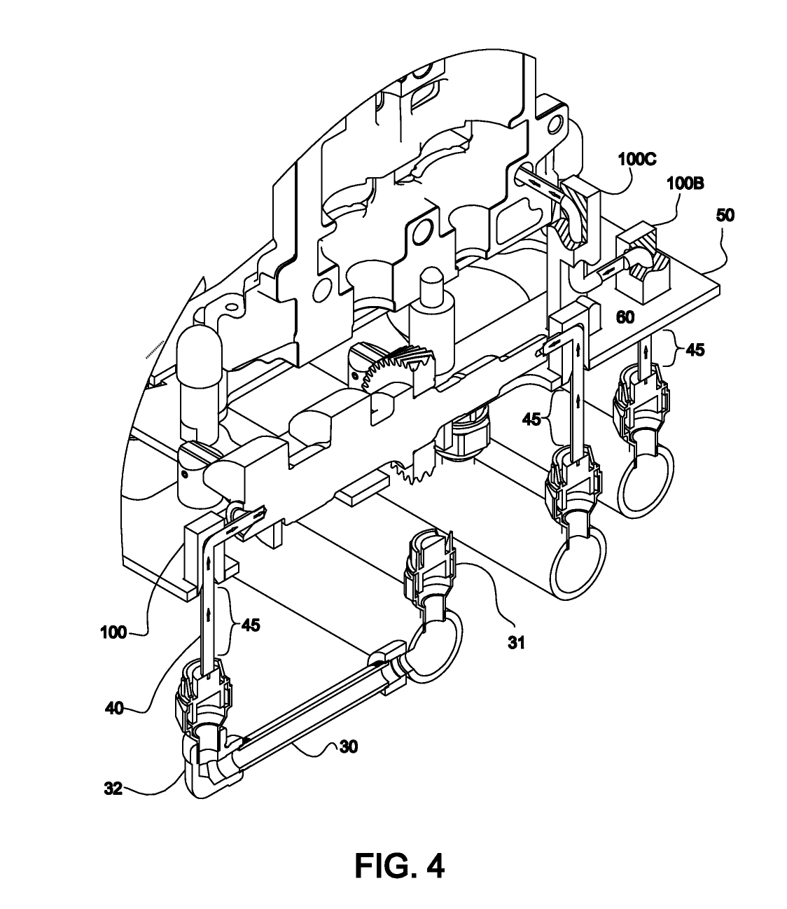

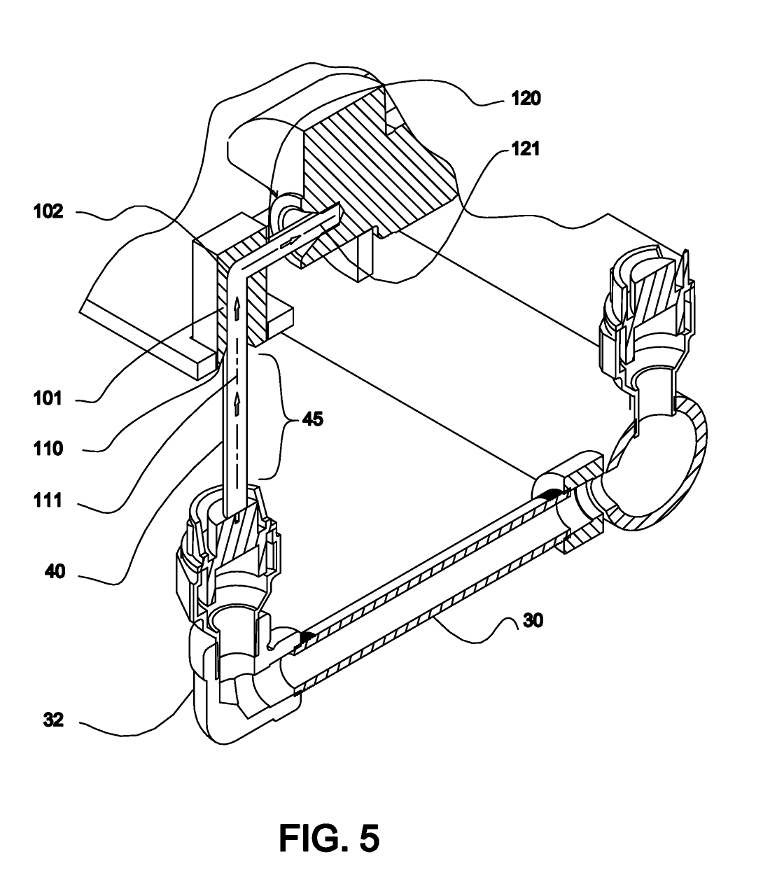

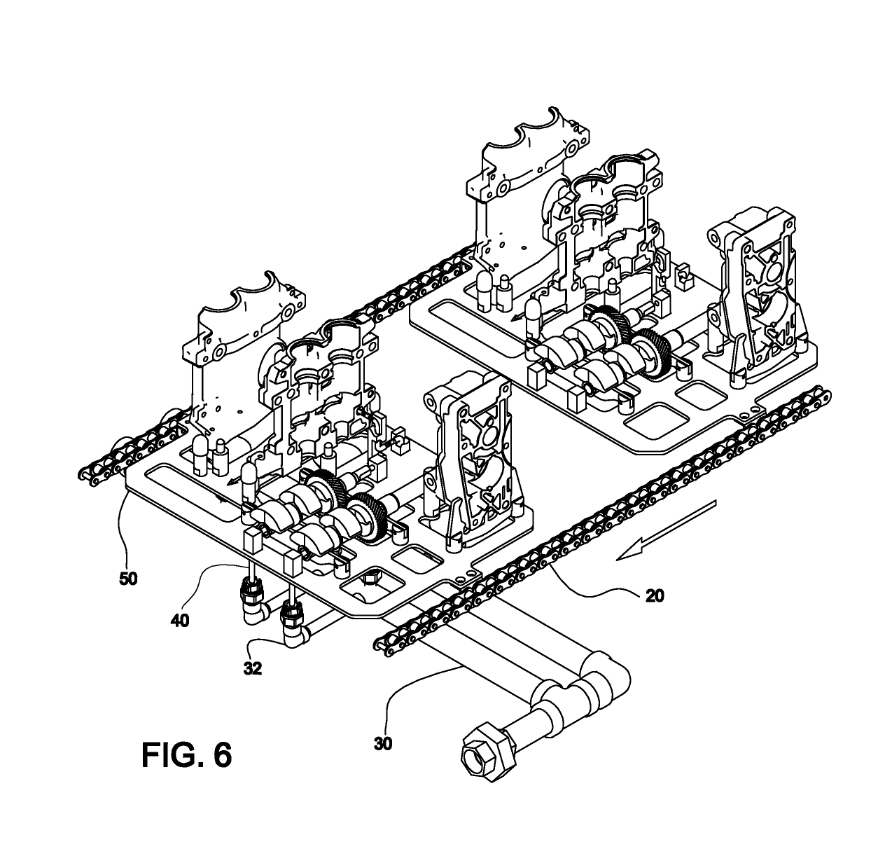

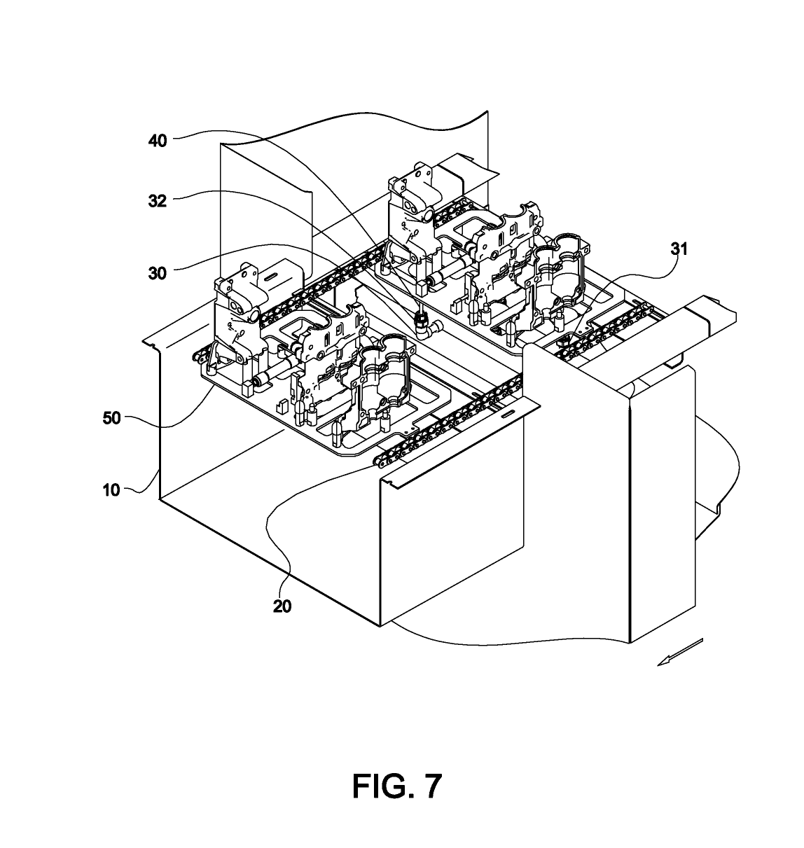

A preferred embodiment of the present invention is illustrated in FIGS. 1-7. Looking first at FIG. 7, it is seen that a parts washer 10 is shown in a generic form. The washer 10 has a conveyor 20 and a liquid distribution assembly 30 that includes nozzles 31 and 32. The liquid 40 can be any type of washing, cleaning or rinsing solution as dictated by the particular application. Nozzle 31 can be a spray nozzle that broadcasts spray therefrom. Nozzle 32 can be a straight stream nozzle capable of sending or exiting a stream of liquid. The liquid is sent preferably in a columnar form.

Gasses can also be used with the present invention for drying, dusting or other reasons requiring a stream of gas to be directed against parts. One preferred gas is air.

Looking now to FIGS. 1-5, it is seen that a carriage 50 is provided. The carriage 50, or fixture, has a top 51, a bottom 52, a leading edge 53, a trailing edged 54 and two opposed sides 55 and 56, respectively. A surface 60 is provided with parts supports 61 and openings 62 there through. The parts supports 61 are used to hold parts that are contained on the carriage 50. The openings 62 allow liquid to be sprayed upon the parts from underneath the carriage by passing through the holes. It is appreciated that additional spray nozzles can be provided to operate from the sides and top of the of the inside of the parts washer.

One or more redirectors 100 (and 100A, 100B, 100C, etc.) can be used in connection with the carriage 50. The redirector 100 can be permanently or removably connected to the carriage 50. The redirector has a body 101. Body 101 can have the shape of a block as it is illustrated. However, the body 101 can have any other exterior shape without departing from the broad aspects of the present invention. Body 100 has a passage 102 with an inlet 110 with an inlet axis 111. The body 100 also has an outlet 120 with an outlet axis 121.

The profile of the passage 102 is preferably generally circular. However, other profiles can be used without departing from the broad aspects of the present invention.

The outlet axis 121 is preferably oriented differently than the inlet axis. In a preferred embodiment, the inlet axis is oriented vertically and the outlet axis is offset 90 degrees wherein it is oriented horizontally and parallel with the plane of the carriage. Yet, it is appreciated that the offset can be made to any desired angle with respect to the inlet axis. The outlet axis 121 can be oriented in any radial direction.

It is appreciated that more than one redirector can be used in sequence. In this regard, the liquid stream can change direction multiple times. The inlet of the first redirector 100B is first aligned with the outlet of the primary nozzle. Then, the inlet of the second redirector 100C is aligned with the outlet of the first redirector 100B. The outlet of the second redirector 100C is aligned to the location on the part to be washed.

In an indexing operation, the carriage 50 is advanced on the conveyor 20 to the wash position. Nozzle 31 is aligned to spray directly onto parts on the carriage 50. Nozzle 32 (primary nozzle) is aligned with the inlet axis of the redirector 100. Liquid 40 is discharged through the nozzles 31 and 32 and the parts are washed. Liquid exiting nozzle 32 spans gap 45 enters the redirector 100, changes directions within the body 110 and exits the redirector in a different orientation than which it entered. The gap 45 could be variable depending in part on clearance obstructions, liquid pressures and other variables.

It is appreciated that many redirectors 100, 100A, 100B and 100C, for example, can be used. There is no limit to the number of redirectors that can be used with the present invention.

It is further appreciated that the redirectors can have different heights without departing from the broad aspects of the present invention as dictated by the location and orientation of the desired washing spray or stream.

The redirectors can have stream, spray or other discharge patterns that can include but not be limited to hollow cone, solid cone, split spray or any other pattern.

It is also appreciated that a single redirector can have multiple outlets. It is further appreciated that the present invention can be similarly used in batch systems without departing from the broad aspects of the present invention.

Thus, it is apparent that there has been provided, in accordance with the invention, a parts washing device including one or more redirectors that fully satisfies the objects, aims and advantages as set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

I claim:

1. A parts washer comprising:
a conveyor; and
a carriage movable though said parts washer and having at least one redirector.

2. The parts washer of claim 1 wherein said at least one redirector changes the direction of flow at said at least one redirector.

3. The parts washer of claim 2 wherein said at least one redirector comprises an inlet having an inlet axis and an outlet having an outlet axis, said inlet axis being oriented different than said outlet axis.

4. The parts washer of claim 3 wherein said parts washer has at least one nozzle and said inlet is aligned with said nozzle.

5. The parts washer of claim 4 wherein said inlet axis is vertically aligned within said parts washer.

6. The parts washer of claim 4 wherein there is a gap between said at least one nozzle and said inlet.

7. The parts washer of claim 4 wherein said at least one redirector comprises a first redirector and a second redirector, said second redirector being sequential with said first redirector wherein a flow changes direction two times.

8. The parts washer of claim 3 wherein said outlet has forms a selected spray pattern.

9. The parts washer of claim 1 wherein said redirector is fixed in relation to said carriage as said carriage is moved by said conveyor within said parts washer.

10. The parts washer of claim 1 wherein:
said parts washer has a first nozzle in a first nozzle position and a second nozzle in a second nozzle position, each of said first nozzle and said second nozzle being independently operable;
said carriage is a first carriage having a first carriage redirector that is alignable with said first nozzle; and
said parts washer further has a second carriage movable through said parts washer, said second carriage with a second carriage redirector that is alignable with said second nozzle.

11. A structure for washing parts, said structure comprising:
a surface with parts supports; and
at least one redirector.

12. The structure of claim 11 wherein said structure is a fixture.

13. The structure of claim 11 wherein said structure is a carriage movable by a conveyor within a parts washer.

14. The structure of claim 11 wherein said at least one redirector comprises an inlet having an inlet axis and an outlet having an outlet axis, said inlet axis being oriented different than said outlet axis

15. The structure of claim 14 wherein said redirector comprises a passage between said inlet and said outlet.

16. The structure of claim 14 wherein said inlet is alignable with a nozzle of a parts washing machine to receive a flow for redirection.

17. A redirector for use within a parts washer, said redirector comprising:
an inlet operable upon an inlet axis; and
an outlet operable upon an outlet axis, said outlet axis being oriented differently than said inlet axis.

18. The redirector of claim 17 further comprising a passage between said inlet and said outlet.

19. The redirector of claim 17 wherein said outlet axis is oriented 90 degrees from said inlet axis.

20. The redirector of claim 17 wherein said outlet has a spray pattern.
